(19) United States
(12) Patent Application Publication
(10) Pub. No.: US 2021/0316608 A1
(43) Pub. Date: Oct. 14, 2021

(54) ELECTRIC VEHICLE PROPULSION SYSTEM

(71) Applicant: VALEO EMBRAYAGES, Amiens Cedex 2 (FR)

(72) Inventors: Olivier MARECHAL, Cergy Pontoise Cedex (FR); Benoit COUTURIER, Cergy Pontoise Cedex (FR)

(73) Assignee: VALEO EMBRAYAGES, Amiens Cedex 2 (FR)

(21) Appl. No.: 17/265,335

(22) PCT Filed: Aug. 1, 2019
(86) PCT No.: PCT/EP2019/070835

§ 371 Date: Feb. 2, 2021

(30) Foreign Application Priority Data
Aug. 3, 2018 (FR) 1857280

(51) Int. Cl. B60K 17/08; B60K 1/02; B60K 17/02; B60L 15/20; F16D 21/02; F16H 61/00; H02K 7/00; H02K 7/108; H02K 7/116; H02P 5/485

(52) U.S. Cl. CPC B60K 17/08; B60K 1/02; B60K 17/02; B60L 15/20; F16D 21/02; F16D 11/14; H02K 7/006; H02K 7/108; H02K 7/116; H02P 5/485; F16H 61/0059

(57) ABSTRACT

A propulsion system for an electric vehicle including a first electric propulsion motor comprising a stator and a rotor having a first output shaft able to rotate about a first axis, a second electric propulsion motor comprising a stator and a rotor having a second output shaft able to rotate about a second axis, a first reducer able to receive the torque supplied by the first electric motor, via a first selective or non-selective coupling system, this first reducer having a first reduction ratio, a second reducer able to receive the torque supplied by the second electric motor, via a second selective or non-selective coupling system, this second reducer having a second reduction ratio, a third coupling system, which may or may not be selective, for coupling the first output shaft and the second output shaft, and the first axis and the second axis not being coincident.

The present invention relates to a propulsion system for an electric vehicle. Such a vehicle has purely electrical propulsion, having no propulsion combustion engine.

The invention relates in particular to a propulsion system for an electric vehicle comprising two distinct electric motors and two distinct reducers so as to be able to provide the user of the vehicle with a number of distinct modes of operation.

Such a propulsion system is known for example from utility certificate FR 2 976 142. The propulsion system according to that utility certificate offers four different modes of operation, namely: (i) operation in the gear ratio of the first reducer using the first electric motor alone, (ii) operation in the gear ratio of the second reducer using the second electric motor alone, (iii) operation in the gear ratio of the first reducer using both electric motors, and (iv) operation in the gear ratio of the second reducer using both electric motors. The system according to that utility certificate FR 2 976 142 offers electric motors, the output shafts of which are axially in the continuation of one another. Such a propulsion system is restrictive because of this alignment of the output shafts since it presupposes a sufficiently large space to receive these electric motors.

A propulsion system similar to that disclosed by FR 2 976 142 is also known from the application JP 2011-033077.

There is still a need to further improve electric vehicle propulsion systems having two electric motors and two reducers.

The invention aims to meet this need and does so, according to one of its aspects, using a propulsion system for an electric vehicle, comprising:

a first electric propulsion motor comprising a stator and a rotor having a first output shaft able to rotate about a first axis,

a second electric propulsion motor comprising a stator and a rotor having a second output shaft able to rotate about a second axis,

at least a first reducer able to receive the torque supplied by the first electric motor, where appropriate via a first selective or non-selective coupling system, this first reducer having a first reduction ratio,

at least a second reducer able to receive the torque supplied by the second electric motor, where appropriate via a second selective or non-selective coupling system, this second reducer having a second reduction ratio,

a third coupling system, which may or may not be selective, for coupling the first output shaft and the second output shaft, the first axis of rotation and the second axis of rotation not being coincident.

The fact that the first and the second output shaft are not aligned makes it possible to fit the propulsion system in a smaller space, axially speaking.

Within the meaning of the present application:

a coupling system coupling two components is selective when it allows the two components to be coupled or uncoupled according to the instruction received,

a coupling system coupling two components and which is not selective permanently couples these two components,

two components coupled by one of the aforementioned coupling systems are secured to one another such that they rotate as one. This securing may correspond to torque lockup in instances in which the coupling system employs a dog clutch and this securing may employ a friction transmission in instances in which the coupling system employs a clutch, and

“upstream” and “downstream” are defined with respect to the direction of torque transfer from an electric motor toward the wheels of the vehicle.

The first axis of rotation and the second axis of rotation may be parallel. In a variant, these two axes of rotation are secant.

The first reducer may be connected to the first output shaft of the first electric motor via a first selective or non-selective coupling system. Such an arrangement of the first reducer with respect to the first coupling system makes it possible to limit the value of the torque that this first coupling system has to transmit so that the bulkiness and/or the weight and/or the cost of this first coupling system can be reduced.

In a variant, the first selective or non-selective coupling system is connected to the first output shaft of the first electric motor via the first reducer.

The second reducer may be connected to the second output shaft of the second electric motor via the second coupling system. In a way similar to that mentioned with reference to the first coupling system, positioning the second coupling system upstream of the second reducer makes it possible to limit the value of the torque that this second coupling system has to transmit.

As a variant, the second coupling system is connected to the second output shaft of the second electric motor via the second reducer.

Throughout the foregoing, the first reducer may be a single reducer and the second reducer may be a single reducer. The ratio between the first reduction gear-ratio and the second reduction gear-ratio may be comprised between 1 and 5, notably between 1.1 and 3.

In the case of a propulsion system with a single first reducer, the propulsion system may comprise a selection member for selecting the first reducer, allowing this reducer to be coupled selectively to the rest of the propulsion system. When the first coupling system connects the first reducer to the first output shaft of the first electric motor, and this first reducer is uncoupled from this first output shaft, such a selection member makes it possible to avoid driving this first reducer from the downstream side. That then means that this first reducer can achieve a fully uncoupled state. Where appropriate, such a selection member may be present even though no first coupling system is present. The cost of the propulsion system can thus be reduced by saving on the first coupling system.

In the case of a propulsion system with a single second reducer, the propulsion system may comprise a selection member for selecting the second reducer, allowing this reducer to be coupled selectively to the rest of the propulsion system. When the second uncoupling system connects the second reducer and the second output shaft of the second electric motor, and this second reducer is uncoupled from this second output shaft, such a selection member makes it possible to avoid driving this second reducer from the downstream side from the point of view of the path followed by the torque. That then means that this second reducer can achieve a fully uncoupled state. Where appropriate, such a selection member may be present even though no second coupling system is present. The cost of the propulsion system can thus be reduced by saving on the second coupling system.

As a variant, several first reducers, notably two first reducers, with first reduction gear ratios that differ from one first reducer to the other, may be arranged in parallel and/or several second reducers, notably two second reducers, with second reduction gear ratios that differ from one second reducer to the other, may be arranged in parallel. The number of first reducers may or may not be the same as the number of second reducers.

When there are several first reducers in parallel, a member for selecting one of these first reducers may be provided, so as to select the first reducer that has the most appropriate first reduction gear ratio.

When there are several second reducers in parallel, a member for selecting one of these second reducers may be provided, so as to select the second reducer that has the most appropriate second reduction gear ratio.

In the case of a propulsion system having several first reducers and/or having several second reducers, it is possible where appropriate to have no first coupling system and no second coupling system, the aforementioned selection members then alone performing the selective-coupling function.

In the case of several first reducers and several second reducers, the ratio between the highest reduction gear ratio and the lowest reduction gear ratio, considered across all of the first and second reducers, may be comprised between 1 and 5, notably being comprised between 1.1 and 3.

When two first reducers are in parallel and two second reducers are in parallel, it is possible to obtain a propulsion system having four different gear ratios.

Each coupling system for example employs a clutch. The choice of a clutch makes it possible to enjoy coupling and uncoupling that are progressive.

When the first coupling system and the second coupling system employ clutches, the first and the second coupling system may be grouped together within a dry dual clutch or a wet dual clutch.

In a variant, each coupling system may be of another type, for example employing a dog clutch or another system. In yet another variant, the coupling systems may be of different types compared with one another.

The first coupling system and the second coupling system for example employ a clutch, and the third coupling system employs a dog clutch, or this third coupling system is not selective.

In yet another variant, the first coupling system and the second coupling system employ a dog clutch, and the third coupling system employs for example a clutch, or dog clutch, or a non-selective coupling system.

Whether the first and second coupling systems employ a clutch or dog clutch, the third coupling system may be chosen from:

the assembly made up of: a pinion gear secured to rotate as one with the output shaft of one of the two electric motors, and meshing with a first idling pinion gear mounted with the ability to rotate freely on an intermediate shaft, a pinion gear secured to rotate as one with the output shaft of the other of the two electric motors and meshing with a second pinion gear secured to rotate as one with the intermediate shaft, and a coupling member for the selective or non-selective coupling of the first pinion gear and of the second pinion gear, this coupling member being, for example, a dog clutch, or

the assembly made up of: an idling pinion gear mounted with the ability to rotate freely on the output shaft of one of the two electric motors, this idling pinion gear meshing with a first pinion gear secured to rotate as one with an intermediate shaft, a pinion gear secured to rotate as one with the output shaft of the other of the two electric motors and meshing with a second pinion gear secured to rotate as one with the intermediate shaft, and a coupling member for the selective coupling of the idling pinion gear and of the output shaft of the electric motor on which output shaft this idling pinion gear is mounted, this coupling member being, for example, a dog clutch, or

the assembly made up of: an idling sprocket gear mounted with the ability to rotate freely on the output shaft of one of the two electric motors, this sprocket gear meshing with a chain, and a sprocket gear secured to rotate as one with the output shaft of the other of the two electric motors and meshing with the chain, and a coupling member for the selective coupling of the idling sprocket gear with the output shaft of the electric motor on which output shaft this idling sprocket gear is mounted, this coupling member being, for example, a dog clutch, or

the assembly made up of: a sprocket gear secured to rotate as one with the output shaft of the first electric motor, a sprocket gear secured to rotate as one with the output shaft of the second electric motor, and a chain meshing with each of these sprocket gears. No selective-coupling member is provided here, the third coupling system not being selective in this latter variant.

As a further variant, the third coupling system may be a permanent rigid connection, the first output shaft being for example fixed directly to the second output shaft.

Throughout the foregoing, the propulsion system may comprise a differential arranged in such a way as to receive at least one of: the torque passing via the first reducer, and the torque passing via the second reducer. This differential may be a mechanical differential or an electronic differential controlling the drive torque fed to each driven wheel of the vehicle.

Where appropriate, one or more intermediate gear wheels may be arranged downstream of each of the first and second reducers, and upstream of the differential. These gear wheels, which are common to the path of the torque passing via the first reducer(s) and to the path of the torque passing through the second reducer(s) may or may not form an additional reduction gear ratio. In a variant, no additional gear wheel is arranged between the first reducer(s) and the differential, or between the second reducer(s) and the differential.

Throughout the foregoing, when the propulsion system comprises three coupling systems, this propulsion system may also comprise a control member for controlling the first, second and third coupling system, so that the system can adopt all or some of the following configurations:

a configuration whereby the differential receives the torque passing via the first reducer, this torque being generated by the first electric motor,

a configuration whereby the differential receives the torque passing via the second reducer, this torque being generated by the second electric motor,

a configuration whereby the differential receives the torque passing via the first reducer, this torque being generated by the first electric motor, and also the torque passing via the second reducer, this torque being generated by the second electric motor,

a configuration whereby the differential receives the torque passing via the first reducer, this torque being generated by the first electric motor, and by the second electric motor or, where appropriate, only by the second electric motor,

a configuration whereby the differential receives the torque passing via the second reducer, this torque being generated by the first electric motor, and by the second electric motor or, where appropriate, only by the first electric motor, and

a parking-brake configuration in which the three coupling systems are in the coupled configuration.

When a selection member for the first reducer(s) and/or when a selection member for the second reducer(s) exist(s), the control member above can also control this or these selection members.

The control member is incorporated for example into the vehicle processor (ECU). In a variant, the control member is incorporated into the transmission control unit (TCU). As a further variant, the control member may be modular and the control module for controlling the first and second coupling system is incorporated into the transmission control unit whereas the control module for controlling the third coupling system is incorporated into the ECU.

Throughout the foregoing, the ratio between the nominal torque supplied by the first electric motor and the nominal torque supplied by the second electric motor may be comprised between 1 and 10, for example being comprised between 1 and 4.

The first electric motor and the second electric motor are, for example, of the same type, for example wound-rotor or permanent-magnet synchronous machines. In a variant, they may for example be asynchronous machines.

Throughout the foregoing, when the propulsion system comprises the first coupling system, the second coupling system and the third coupling system, these systems may be distinct from one another. The third coupling system may be formed in full or in part by dedicated elements, namely by one or more elements which belong neither to the first coupling system nor to the second coupling system.

The invention may be better understood on reading the following description of nonlimiting exemplary embodiments thereof and on studying the appended drawing, in which:

FIG. 1 is an elevation view of a propulsion system according to one embodiment of the invention,

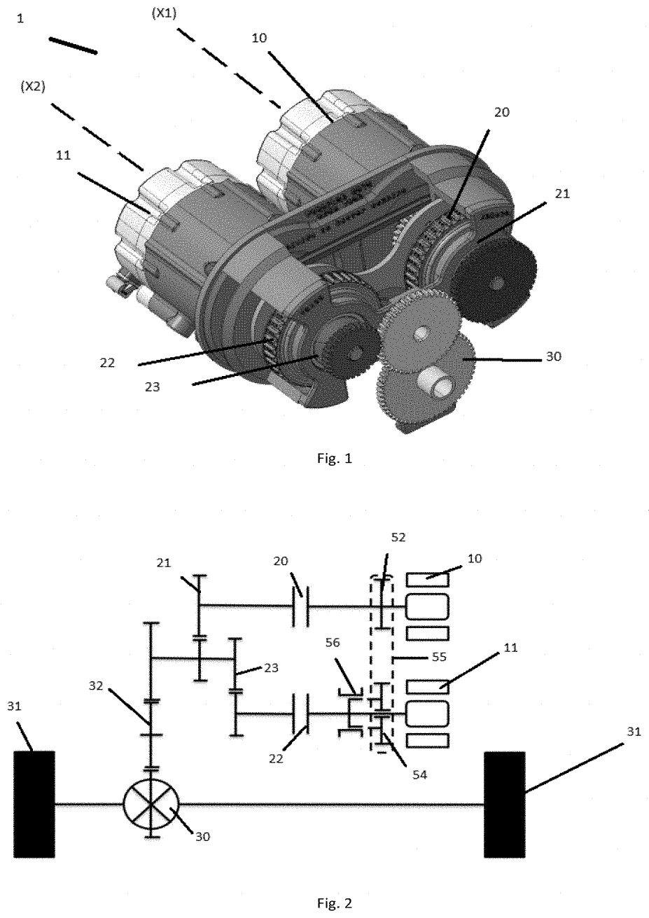

FIG. 2 schematically depicts the propulsion system of FIG. 1,

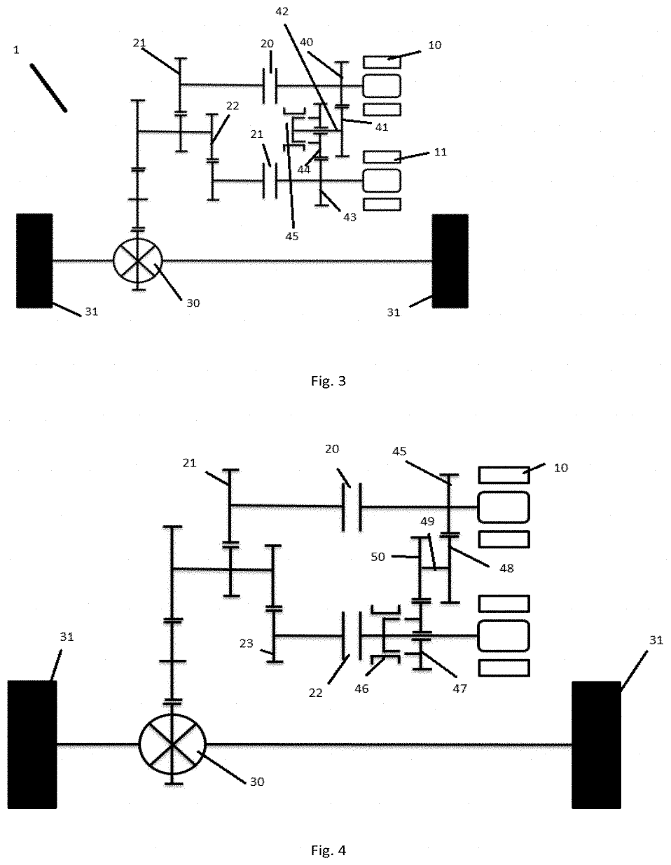

FIGS. 3 to 7 are variants of FIG. 2,

FIG. 8 depicts a clutch that can be used to create a first or second coupling system, and

FIG. 9 depicts a dog clutch that can be used to create a first or second or third coupling system.

FIG. 1 depicts a vehicle propulsion system 1 according to a first embodiment of the invention.

This propulsion system 1 is, in this instance, purely electrical, which means to say that it does not employ any combustion engine to drive the vehicle which in this instance is an automobile. This propulsion system 1 here comprises a first electric motor 10 and a second electric motor 11.

The first electric motor 10 and the second electric motor 11 are, for example, permanent-magnet synchronous machines. The first electric motor 10 for example has a nominal torque of 50 Nm, while the second electric motor 11 for example has a nominal torque of 70 Nm. As can be seen in FIG. 1, the first electric motor 10, 11 has, in the example described, a rotor with a first output shaft rotating about a first axis of rotation X1, and the second electric motor 11 has, in the example described, a rotor having a second output shaft rotating about a second axis of rotation X2. In the example described, the axes of rotation of the first electric motor and of the second electric motor are parallel but not coincident, the two electric motors 10 and 11 not having their axes of rotation aligned.

In the example described with reference to FIGS. 1 and 2, the first output shaft is connected to a first coupling system 20 which in this instance is a selective-coupling system. This coupling system 20 is depicted in the form of a clutch in FIGS. 1 and 2, but could be produced in some other way, for example using a dog clutch.

This first coupling system 20 allows the first output shaft of the first electric motor 10 to be coupled to a first reducer 21 which, for example, has a reduction ratio of the order of 12.

The second output shaft of the second electric motor 11 is, according to the example described with reference to FIGS. 1 and 2, connected to a second coupling system 22 which in this instance is a selective-coupling system. Similarly to that which was mentioned in respect of the first coupling system 20, this system is depicted in the form of a clutch in FIGS. 1 and 2, but could be produced in some other way, for example using a dog clutch.

FIG. 8 depicts an example of a clutch suitable for embodying the first coupling system 20 or for embodying the second coupling system 22. This clutch in this instance is a plate clutch, these plates 26 becoming coupled in order to transmit torque, under the action of a mobile piston.

In a variant, each coupling system 20, 22 could employ a dog clutch, as depicted in FIG. 9. Such a coupling system allows two components to be coupled using dogs 27.

The second coupling system 22 allows the second output shaft of the second electric motor 11 to be coupled to a second reducer 23 which, for example, has a reduction ratio of the order of 8.

The invention is not restricted to the positioning of the first or, respectively, second, coupling system 20 or, respectively, 22, upstream of the first reducer 21 or, respectively, second reducer 23, in the path of the torque generated by the corresponding motor 10 or, respectively, 11. The first or, respectively, second, coupling system 20 or, respectively, 22, may, as a variant, be positioned downstream of the first reducer 21 or, respectively, second reducer 23, in the path of the torque generated by the corresponding motor 10 or, respectively, 11.

The propulsion system 1 further comprises a differential 30. In the examples considered, one or more gear wheels 32 are interposed between the first reducer(s) 21 and the differential 30 and between the second reducer(s) 23 and the differential 30. However, in variants, it is possible for no gear wheel to be provided.

In the example of FIGS. 1 and 2, the propulsion system 1 comprises just one single first reducer 21 and just one single second reducer 22, but the invention is not restricted to that scenario.

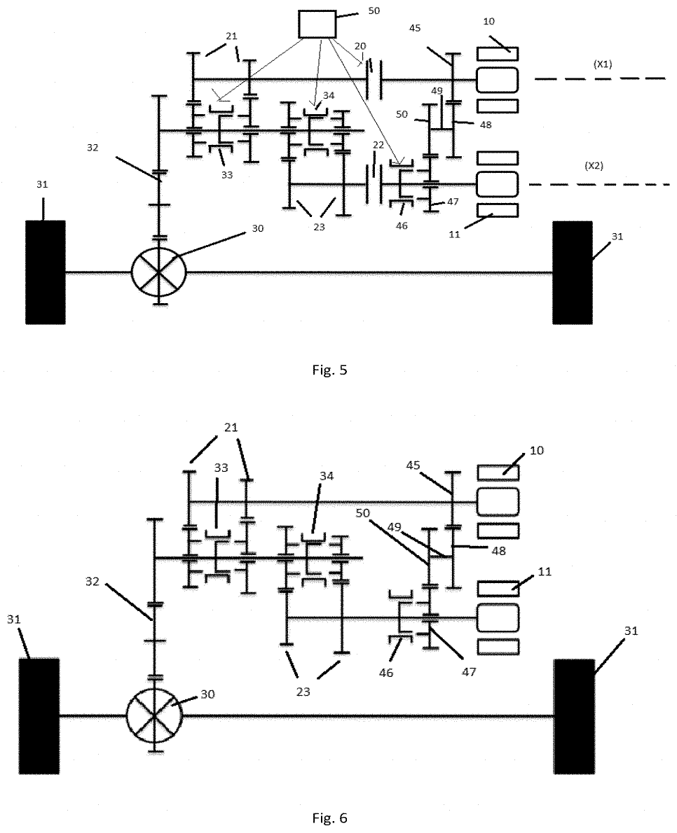

Thus, as depicted in FIGS. 5 and 6, several first reducers 21 may be arranged in parallel between the first shaft of the first electric motor and the differential 30, and several second reducers 23 may be arranged in parallel between the second shaft of the second electric motor 11 and the differential 30.

As may be seen in FIGS. 5 and 6, two first reducers 21 may be arranged in parallel, and two second reducers 23 are arranged in parallel. The two first reducers 21 here have a first reduction ratio that differs from one to the other, just like the two second reducers 23. Where appropriate, a selection member 33 for selecting one of the first reducers 21 and a selection member 34 for selecting one of the second reducers 23 may be provided. Each of these selection members 33, 34 is in this instance a dog clutch.

In the example of FIG. 5, the first coupling system 20 and the selection member 33 are associated with the first reducers 21, and the second coupling system 22 and the selection member 34 are associated with the second reducers 23.

In the example of FIG. 6, there is no first coupling system 20 and 22; the function of uncoupling of the reducers 21 and 23 is performed by the selection members 33 and 34.

It is also possible for the selection members 33 and 34 to be present in instances in which the propulsion system comprises a single first reducer 21 and a single second reducer 22. This selection member 33, 34 therefore allows the corresponding reducer 21, 23 to be uncoupled from its downstream side.

The differential 30 is arranged in such a way as to receive, in the examples described:

the torque available on the first shaft of the first electric motor 10, after passing via the first coupling system 20, where present, and the first reducer 21, and/or

the torque available on the second output shaft of the second electric motor 11, after passing via the optional second coupling system 22, where present, and the second reducer 23 in the example described.

The differential 30 allows the torque to be transmitted to the wheels 31.

As can be seen in FIGS. 1 to 7, the first output shaft of the first electric motor 10 is coupled to the second output shaft of the second electric motor 11. This coupling is done via a third coupling system 35.

This third coupling system 35 may be embodied in different ways, as will now be described.

In FIGS. 1 and 2, this third coupling system 35 is an assembly formed by a sprocket gear 52 secured to rotate as one with the first output shaft of the first electric motor 10, an idling sprocket gear 54 mounted with the ability to rotate freely on the second output shaft of the second electric motor 11, and a chain 55 meshing with each sprocket gear 52 and 54. A dog clutch 56 is provided for selectively coupling the sprocket gear 54 to the second output shaft of the second electric motor 11.

In FIG. 3, this third coupling system 35 is an assembly formed by: a pinion gear 40 secured to rotate as one with the first output shaft of the first electric motor 10, and meshing with a first pinion gear 41 secured to rotate as one with an intermediate shaft 42, a pinion gear 43 secured to rotate as one with the second output shaft of the second electric motor 11 and meshing with an idling second pinion gear 44 mounted to rotate freely on the intermediate shaft 42, and a dog clutch 45 forming a coupling member for the selective coupling of the first pinion gear 41 and of the second pinion gear 44.

In FIGS. 4 to 6, which differ from one another as has been seen in terms of the number of first reducers 21 and second reducers 23 and in terms of the presence or absence of the first coupling system 20 and the second coupling system 22, the third coupling system is an assembly formed by a pinion gear 45 secured to rotate as one with the first output shaft of the first electric motor 10, an idling pinion gear 47 mounted to rotate freely on the second output shaft of the second electric motor 11, a first pinion gear 48 secured to rotate as one with an intermediate shaft 49 and meshing with the pinion gear 45, a second pinion gear 50 secured to rotate as one with the intermediate shaft 49 and meshing with the pinion gear 47, and a dog clutch 46 allowing the pinion gear 47 to be selectively coupled to the second output shaft on which it is mounted. In a variant, the pinion gears 48, 50 and the intermediate shaft 49 may be omitted, the idling pinion gear 47 meshing directly with the pinion gear 45.

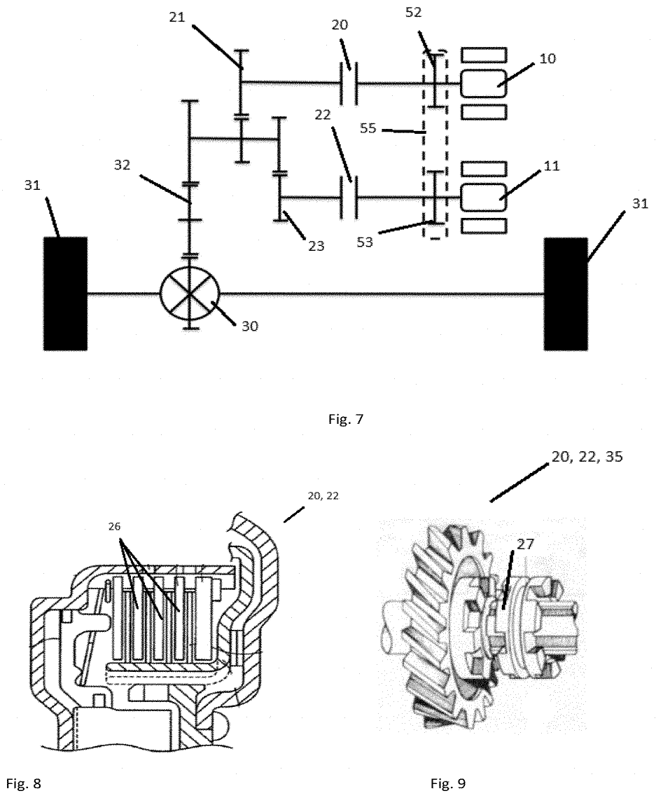

In FIG. 7, the third coupling system is an assembly formed by a sprocket gear 52 secured to rotate as one with the first output shaft of the first electric motor 10, a sprocket gear 53 secured to rotate as one with the second output shaft of the second electric motor 11, and a chain 55 meshing with each sprocket gear 52 and 53. No selective-coupling means is provided here, the third coupling system 35 not being selective in this instance.

Other examples are possible for embodying a selective or non-selective third coupling system, for example a clutch.

In an additional variant, the first coupling system 20 and the second coupling system 22 employ dog clutches, and the third coupling system 35 employs a clutch.

Throughout the foregoing, the propulsion system may further comprise a control member 50 for controlling the first 20, second 22 and third 35 coupling systems when these three coupling systems are present. When several first reducers 21 and/or several second reducers 23 are present, the control member 50 may also make it possible to select one of the reducers, where appropriate via a module specific to these first reducers or to these second reducers, this specific module operating a selection member 33 or 34 as mentioned hereinabove. As already mentioned, these selection members may be present with a single first reducer and a single second reducer, in which case they can be controlled by the control member 50, without there necessarily having to be a first coupling system 20 and a second coupling system 22.

The control member 50 is programmed so that the propulsion system can adopt the following configurations:

a configuration (i) whereby the differential 30 receives the torque passing via the first reducer 21, this torque being generated by the first electric motor 10,

a configuration (ii) whereby the differential 30 receives the torque passing via the second reducer 23, this torque being generated by the second electric motor 11,

a configuration (iii) whereby the differential 30 receives the torque passing via the first reducer 21, this torque being generated by the first electric motor 10, and also the torque passing via the second reducer 23, this torque being generated by the second electric motor 11,

a configuration (iv) whereby the differential 30 receives the torque passing via the first reducer 21, this torque being generated by the first electric motor 10, and by the second electric motor 11 or, where appropriate, only by the second electric motor 11 when the first electric motor 10 is switched off, and

a configuration (v) whereby the differential receives the torque passing via the second reducer 23, this torque being generated by the first electric motor 10, and by the second electric motor 11 or, where appropriate, only by the first electric motor 10 when the second electric motor 11 is switched off, and

a configuration (vi) whereby each coupling system 20, 22 and 35 is in a coupled position.

The commands used by the control member 50 to control the coupling systems in order to obtain the configurations (i) to (vi) above are given in the table below.

| | First coupling | Second coupling | Third coupling |
|---|---|---|---|
| Configuration | system (20) | system (22) | system (35) |
| (i) | Couple | Uncouple | Uncouple |
| (ii) | Uncouple | Couple | Uncouple |
| (iii) | Couple | Couple | Uncouple |
| (iv) | Couple | Uncouple | Couple |
| (v) | Uncouple | Couple | Couple |
| (vi) | Couple | Couple | Couple |

Configuration (i) is for example suited to low vehicle speeds with low torque demands.

Configuration (ii) is for example suited to high vehicle speeds with low torque demands.

Configuration (iii) is for example suited to transient speeds, for example when making the transition from one reduction ratio to another.

Configuration (iv) is for example suited to low vehicle speeds with high torque demands.

Configuration (v) is for example suited to high vehicle speeds with high torque demands.

Configuration (vi) is for example suited to operation as a parking brake.

The invention is not limited to the examples that have been described above.

1. A propulsion system for an electric vehicle, comprising:
a first electric propulsion motor comprising a stator and a rotor having a first output shaft able to rotate about a first axis,
a second electric propulsion motor comprising a stator and a rotor having a second output shaft able to rotate about a second axis,
a first reducer able to receive the torque supplied by the first electric motor, via a first selective or non-selective coupling system, this first reducer having a first reduction ratio,
a second reducer able to receive the torque supplied by the second electric motor, via a second selective or non-selective coupling system, this second reducer having a second reduction ratio,
a third coupling system, which may or may not be selective, for coupling the first output shaft and the second output shaft,
the first axis and the second axis not being coincident.

2. The propulsion system as claimed in claim 1, the first axis and the second axis being parallel.

3. The propulsion system as claimed in claim 1, the first reducer being connected to the first output shaft of the first electric motor via a first selective or non-selective coupling system.

4. The propulsion system as claimed in claim 1, the second reducer being connected to the second shaft of the second electric motor via the second selective or non-selective coupling system.

5. The system as claimed in claim 1, each coupling system employing a clutch.

6. The system as claimed in claim 3, the first coupling system and the second coupling system employing a clutch, and
the third coupling system employing a dog clutch, or being non-selective.

7. The system as claimed in claim 3, the first coupling system and the second coupling system employing a dog clutch, and
the third coupling system employing a dog clutch, or being non-selective.

8. The system as claimed in claim 1, comprising a differential arranged in such a way as to receive at least one of: the torque passing via the first reducer, and the torque passing via the second reducer.

9. The system as claimed in claim 3, comprising a control member for controlling the first, second and third coupling system so that the propulsion system can adopt all or some of the following configurations:
a configuration (i) whereby the differential receives the torque passing via the first reducer, this torque being generated by the first electric motor,
a configuration (ii) whereby the differential receives the torque passing via the second reducer, this torque being generated by the second electric motor,
a configuration (iii) whereby the differential receives the torque passing via the first reducer, this torque being generated by the first electric motor, and also the torque passing via the second reducer, this torque being generated by the second electric motor,
a configuration whereby the differential receives the torque passing via the first reducer, this torque being generated by the first electric motor, and by the second electric motor or, where appropriate, only by the second electric motor, and
a configuration whereby the differential receives the torque passing via the second reducer, this torque being generated by the first electric motor and by the second electric motor or, where appropriate, only by the first electric motor, and
a parking-brake configuration (vi) in which the three coupling systems are in the coupled configuration.

10. The system as claimed in claim 1, comprising at least one of:
two of the first reducers, with first reduction gear ratios that differ from each other, being arranged in parallel, and
two of the second reducers, with second reduction gear ratios that differ from each other, being arranged in parallel.

11. The system as claimed in claim 3, the third coupling system comprising at least one element which belongs neither to the first coupling system, nor to the second coupling system.
